(19) United States
(12) Patent Application Publication
(10) Pub. No.: US 2015/0027045 A1
(43) Pub. Date: Jan. 29, 2015

(54) PLANT GROWING SYSTEM

(71) Applicant: E. KRIEGER GREENHOUSES, INC., Jefferson, IA (US)

(72) Inventors: Andy Krieger, Jefferson, IA (US); Ross Krieger, Boone, IA (US); Kurt Krieger, Jefferson, IA (US)

(73) Assignee: E. KRIEGER GREENHOUSES, INC., Jefferson, IA (US)

(21) Appl. No.: 13/952,804

(22) Filed: Jul. 29, 2013

(51) Int. Cl. A01G 9/02

(52) U.S. Cl. CPC A01G 9/02
USPC 47/65.5

(57) ABSTRACT

A plant growing system having a pot with a bottom and sidewalls that form a hollow chamber. A quantity of mixture is disposed within the hollow chamber that includes a growing media, a time released fertilizer, and a water polymer. Covering the top of the pot is a lid that is formed to fit the top of the pot and when removed, fits the bottom of the pot for use as a watering tray.

### BACKGROUND OF THE INVENTION

This invention is directed to a plant growing system and more particularly, a plant growing system that makes the plant growing process easier.

For a beginner, inexperienced in growing plants, the process can be overwhelming requiring time, knowledge, and sometimes space. While one can learn through study and/or the process of trial and error, not only do many not want to put in the time and effort, but through the process, soil and fertilizer are wasted. Therefore, there is a need in the art for a plant growing system that addresses these deficiencies.

An objective of the present invention is to provide a plant growing system that simplifies the process of growing plants.

Another objective of the present invention is to provide a plant growing system packaged in a ready to use plant growing kit.

These and other objectives will be apparent to one of ordinary skill in the art based upon the following written description, drawings and claims.

### SUMMARY OF THE INVENTION

A plant growing system having a pot with a bottom and sidewalls that form a hollow chamber. A quantity of mixture is disposed within the hollow chamber that includes a growing media, a time released fertilizer, and a water polymer. Covering the top of the pot is a lid that is formed to fit the top of the pot and when removed, fits the bottom of the pot for use as a watering tray.

### BRIEF DESCRIPTION OF THE DRAWINGS

FIG. 1 is a perspective view of a plant growing system; and

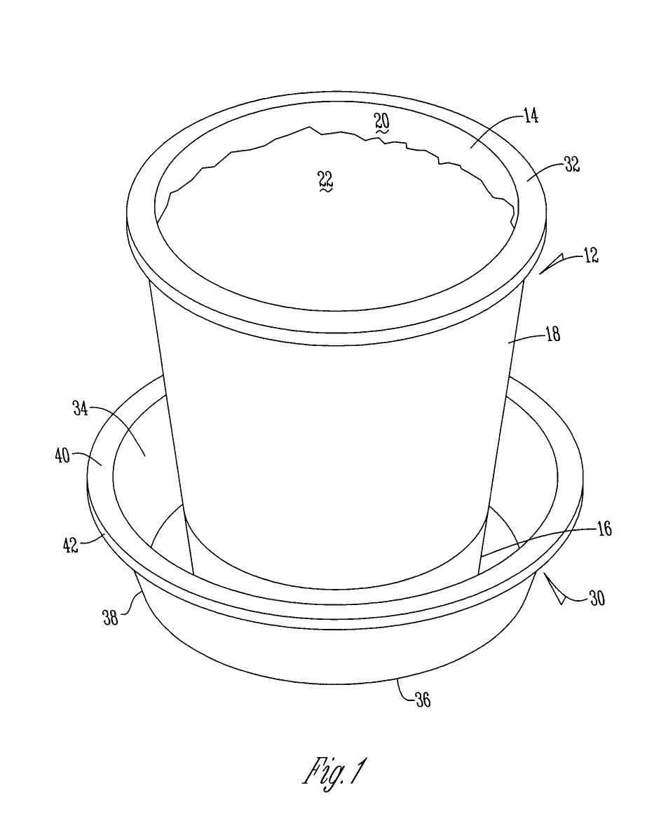

FIG. 2 is a side sectional view of a plant growing system.

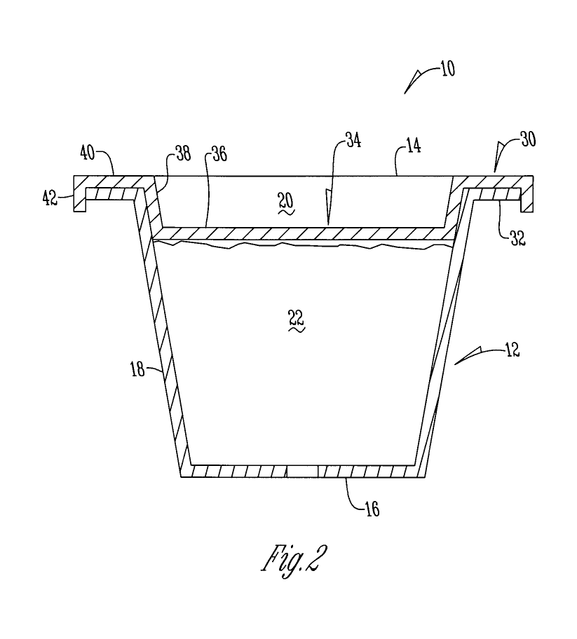

### DETAILED DESCRIPTION OF THE PREFERRED EMBODIMENTS

Referring to the Figures, the plant growing system 10 includes a pot 12 having an open top 14, a bottom 16, and a sidewall 18 that form a hollow chamber 20. The pot is of any size and shape, but preferably is three to nineteen inches, and made of plastic, clay, organic or recycled material.

Received within the hollow chamber 20 is a mixture 22 of growing media, time released fertilizer, and a water polymer. The growing media is of any type and preferably includes 50% to 90% peat moss, compost or the like; 10% to 20% perlite or other substrate such as vermiculite, rice hulls, rice chap, processed pine bark, Styrofoam or the other like material used for increasing air space, a starter charge of fertilizer equal to 20-10-20 at 100 ppm Nitrogen or the like that is adjusted with lime and wetting agent or the like.

The time released fertilizer is of any type and preferably is of a quantity of 2 to 10 lb. per square yard of growing media, with a time release of 2 to 9 months, and a composite or the like of 15-9-12. The water polymer is of any type and preferably is a Hydro-gel/Stockosorb or the like and is of a quantity of 2 to 5 pounds per square yard of growing media.

Once filled, the pot 12 is covered with a lid 30. The lid 30 is formed to fit over and follow the top edge 32 of the pot 12 with a center portion 34 that fits within the hollow chamber 20 of the pot 12 and engages the top surface of the mixture 22. In one example, the center portion 34 has a bottom wall 36 and a sidewall 38 that engages the inner surface of the sidewall 18 of the pot 12. The lid sidewall 38 terminates in a flange 40 that extends over the top edge 32 of the pot 12. The flange 40 terminates in a lip 42 that extends downwardly below the top edge 32 of the pot 12.

To use the plant growing system 10, a user removes the lid 30 and places the lid 30 underneath the pot 12 such that the bottom 16 of the pot 12 fits within the central portion 34 of the lid 30 which serves as a watering tray for the pot 12. The user then plants the seeds or live plant material as instructed at the desired depth of the mixture 22. Any type of seed may be used for flowers, bulbs, lettuce, spinach, radishes, turnips, kale, or other greens. Once the seeds are planted, water is added to the lid 30 (i.e., water tray) and water seeps through openings in the bottom 16 of the pot 12, into the mixture 22 and to the seeds.

What is claimed is:

1. A plant growing system, comprising:
a pot having a bottom and a sidewall that form a hollow chamber;
a quantity of mixture having growth media, time released fertilizer, and a water polymer; and
a lid that fits over the pot and can be used as a water tray.

2. The system of claim 1 wherein the growth media includes 50% to 90% peat moss or other organic matter.

3. The system of claim 1 wherein the growth media includes 10% to 20% perlite.

4. The system of claim 1 wherein the growth media is adjusted with lime and a wetting agent.

5. The system of claim 1 wherein the fertilizer has a time release of 2 to 9 months.

6. The system of claim 1 wherein the fertilizer is of a quantity of 2 to 10 pounds per square yard of growing media.

7. The system of claim 1 wherein the water polymer is of a quantity of 2 to 5 pounds per square yard of growing media.
